(19) United States
(12) Patent Application Publication
(10) Pub. No.: US 2007/0008400 A1
(43) Pub. Date: Jan. 11, 2007

(54) Image forming apparatus and light scanning apparatus

(75) Inventor: Young-min Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/432,346

(22) Filed: May 12, 2006

(30) Foreign Application Priority Data
Jun. 30, 2005 (KR) 2005-58098

(51) Int. Cl. B41J 2/435

(52) U.S. Cl. 347/224

(57) ABSTRACT

An image forming apparatus has a photo sensitive body that includes a light source that scans light to the photo sensitive body; a frame supporting the light source and formed with a hole; a light interceptor that is disposed on a light traveling path of the light source and that is disposed in the hole so that it can be moved between an intercepting position in which the light from the light source is intercepted and a withdrawn position in which the light interceptor is withdrawn from the intercepting position and in which the light from the light source is not intercepted; and a sealing member that seals the hole while allowing the light interceptor to move in the hole. Thus, the image forming apparatus and a light scanning apparatus can prevent a contaminated image from being generated.

### CROSS-REFERENCE TO RELATED APPLICATIONS

This application claims the benefit of Korean Patent Application No. 2005-0058098, filed on Jun. 30, 2005, in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to an image forming apparatus in which generation of a contaminated image is prevented.

2. Description of the Related Art

In general, methods for forming an image in an image forming apparatus include an electro-photographic method in which a developing agent is applied onto an electrostatic latent image formed on a photo sensitive body by a potential difference to develop the electrostatic latent image and in which the developed electrostatic latent image is then transferred to a printing paper to form an image, an ink jet method in which ink is jetted on a printing paper through a plurality of ink jet nozzles to form an image, and a dye sublimation method in which an ink ribbon is contacted with a printing paper and the ink ribbon is heated selectively to form an image and other various methods. The image forming apparatus using the above-described electro-photographic method is widely used, since it is possible to print at a high speed and obtain a printed image with a high definition and at a low manufacturing cost.

An image forming apparatus that uses the electro-photographic method typically has a feeder, a light scanning unit (LSU), a developer, a fuser and a discharger. The feeder feeds printing paper to the image forming unit, the light scanning unit scans light onto a photosensitive body in the developer, and then the developer selectively applies developing agent to the printing paper to form the printing image. The fuser applies heat and pressure such that the applied developing agent is fused to the printing paper. The discharger receives the printing paper to which the developing agent is fused and discharges it to the outside. The developer typically includes a photo sensitive body, a developing roller and a transfer charge roller. After the light scanning unit scans the light onto the photo sensitive body to form the electrostatic latent image, the developing roller feeds the developing agent to the electrostatic latent image of the photo sensitive body to develop the latent image, and the transfer charge roller transfers the image formed on the photo sensitive body to the printing paper.

The light scanning unit comprises a light source that scans light. In general, a laser diode (LD) is used as the light source. Instead of the laser diode, an LED array unit in which a plurality of laser emitting diode (LED) devices are arranged, or other light sources, may be used.

For the safety of users, particularly users who may need to open the cover of the main body housing, it is desirable that light from the light source be intercepted if the cover of the main body housing is opened, so that the user is not exposed to light from the light source.

FIG. 1 is a schematic view showing a conventional image forming apparatus. As shown in FIG. 1, an image forming apparatus 1 comprises a main body housing 30, a cover 40, a developer 11 and a light scanning unit 20. The developer 11 and the light scanning unit 20 are disposed inside the main body housing 30. A feeder (not shown) for storing the printing papers and feeding them to the developer 11, a fuser (not shown) for fusing developing agent applied to the printing paper, a discharger (not shown) for discharging the printing paper on which the image is formed to the outside and other structural elements are accommodated in the main body housing 30.

The cover 40 is rotatably connected to the main body housing 30 through a hinge 42 so that the main body housing 30 can be opened for attaching or detaching the developer 11, for maintenance, or for other various purposes. The developer 11 is provided with a photo sensitive body 13 and can be attached to or detached from the main body housing 30.

The light scanning unit 20 has a light source 21 for scanning light to a photo sensitive body 13 and a frame 22 for supporting the light source 21. A polygon mirror, a scanning lens, a reflecting mirror and other lenses are disposed on a light traveling path between the light source 21 and the photo sensitive body 13. A hole 23 for receiving a light interceptor 24 is provided in the frame 22, which is formed by penetrating the frame 22, so that the light interceptor 24 can be disposed in the hole 23. The light interceptor 24 is rotatably combined with the frame 22 through a hinge 25, so that the light interceptor 24 is received movably in the hole 23. Also, the light interceptor 24 has a light slit 26 disposed on the light traveling path of light from the light source 21 so that light can pass and travel through the light slit 26. The light interceptor 24 can be located so that the light slit 26 allows the light of the light source 21 to pass through, or it can be moved a location so that it intercepts the light from the light source.

The cover 40 has a protrusion 41 which can be contacted with the light interceptor 24 when the main body housing 30 is closed. When the main body housing 30 is closed by the cover part 40, the protrusion 41 presses the light interceptor 24 so that the light slit 26 is placed at a location in which light from the light source 21 passes through the light slit 26. Accordingly, in normal operations, the light source 21 scans light to the photo sensitive body 13, so that a electrostatic latent image can be formed on the photo sensitive body. On the other hand, when the cover 40 of the main body housing 30 is opened, the protrusion portion 41 no longer presses against the light interceptor 24, and the light interceptor 24 moves to a location in which the light from the light source part 21 is intercepted by the light slit 26. Accordingly, when the cover 40 of the main body housing 30 is opened, the light interceptor intercepts light scanned from the light source 21, so that the light interceptor 24 prevents the user from being exposed to the light from the light source part 21. The image forming apparatus 1 as described above is disclosed in detail in Japanese Patent First Publication No. 6-297755.

In the image forming apparatus 1, however, since the light interceptor 24 is moved in the hole 23 to intercept or not intercept the light from the light source 21, a gap G is formed between the frame part 22 and the light interceptor 24 in the hole 23. In particular, when the main body housing 30 is closed by the cover 40, the protrusion 41 presses the light interceptor 24, and thus the gap G may be formed between the frame 22 and the light interceptor 24. A developing agent or other foreign substances can be introduced into the light scanning unit 20 through the gap G.

Foreign substances that are introduced into the light scanning unit 20 may be scattered onto the light traveling path and prevent or intercept the travel of light from the light source part 21, and may thereby prevent the electrostatic latent image from being formed normally on the photo sensitive body 13. Foreign substances introduced from the outside may become attached to a reflecting mirror (not shown), a polygon mirror (not shown), a scanning lens (not shown) and other lenses disposed in the light scanning unit 20, to thereby distort the light of the light source part 21. Accordingly, a contaminated image, such as an image containing a vertical white streak and the like, may be generated.

### SUMMARY OF THE INVENTION

Accordingly, an aspect of the present invention is to provide an image forming apparatus and a light scanning apparatus which can prevent a contaminated image from being generated.

Additional aspects and/or advantages of the invention will be set forth in part in the description which follows and, in part, will be obvious from the description, or may be learned by practice of the invention.

The foregoing and/or other aspects of the present invention can be achieved by providing an image forming apparatus having a photo sensitive body comprising a light source that scans light to the photo sensitive body; a frame supporting the light source and formed with a hole; a light interceptor that is disposed on a light traveling path of the light source and that is disposed in the hole so it can be moved between an intercepting position in which light from the light source part is intercepted and a withdrawn position in which the light interceptor is withdrawn from the intercepting position so that light from the light source is not intercepted; and a sealing member sealing the hole while allowing the light interceptor to be moved in the hole.

According to an aspect of the present invention, the image forming apparatus further comprises a polygon mirror that diffuses and reflects light from the light source in a specific direction, and wherein the light interceptor intercepts light from the light source on the light traveling path between the light source part and the polygon mirror.

According to an aspect of the present invention, the image forming apparatus further comprises a polygon mirror that diffuses and reflects light from the light source in a specific direction and a scanning lens disposed between the polygon mirror and the photo sensitive body to converge the light reflected from the polygon mirror in a specific direction, and wherein the light interceptor intercepts light from the light source on the light traveling path between the polygon mirror and the scanning lens.

According to an aspect of the present invention, the image forming apparatus further comprises a scanning lens that converges light from the light source in a specific direction and a reflecting mirror disposed between the scanning lens and the photo sensitive body to reflect light from the light source in a specific direction, and wherein the light interceptor intercepts light from the light source on the light traveling path between the scanning lens and the reflecting mirror.

According to an aspect of the present invention, the sealing member seals the hole so that the light interceptor can be surrounded by the sealing member, and the sealing member is made from a flexible material.

According to an aspect of the present invention, the sealing member is disposed between the light interceptor and the frame for sealing a clearance formed around the light interceptor received in the hole, and the sealing member is made from a flexible material.

According to an aspect of the present invention, the light interceptor is rotatably combined with the frame for rotating between the intercepting position and the withdrawn position.

According to an aspect of the present invention, the light interceptor has a light slit through which light from the light source part passes when the light interceptor is located in the withdrawn position.

The foregoing and/or other aspects of the present invention can be also achieved by providing an image forming apparatus including a photo sensitive body, a main body housing that receives the photo sensitive body and a cover that rotates for opening and closing the main body housing, comprising a light source that scans light to the photo sensitive body; a frame supporting the light source and formed with a hole; a light interceptor that is disposed on a light traveling path of the light source and that is disposed in the hole so that it is movable between an intercepting position in which light from the light source is intercepted and a withdrawn position in which the light interceptor is withdrawn from the intercepting position; and a sealing member that seals the hole while allowing the light interceptor to be moved in the hole, wherein the cover part comprises a first actuator that actuates the light interceptor for causing or allowing the light interceptor to be located at the intercepting position when the main body housing is opened by a rotation of the cover, and for causing the light interceptor to be located at the withdrawn position when the main body housing is closed by a rotation of the cover.

According to an aspect of the present invention, the image forming apparatus further comprises an elastic member that presses the light interceptor for moving the light interceptor from the withdrawn position to the intercepting position.

The foregoing and/or other aspects of the present invention can be also achieved by providing an image forming apparatus having a main body housing and a developer provided with a photo sensitive body and being attachable to and detachable from the main body housing, comprising a light source that scans light to the photo sensitive body; a frame supporting the light source and formed with a hole; a light interceptor that is disposed on a light traveling path of the light source and disposed in the hole so that it can be moved between an intercepting position in which light from the light source is intercepted and a withdrawn position in which the light interceptor is withdrawn from the intercepting position; and a sealing member sealing the hole while allowing the light interceptor to be moved in the hole, wherein the developer comprises a second actuator that actuates the light interceptor and causes the light interceptor to be located at the withdrawn position when the developer is mounted to the main body housing, and that causes or allows the light interceptor to be located at the intercepting position when the developer is detached from the main body housing.

According to an aspect of the present invention, the image forming apparatus further comprises an elastic member that applies pressure to the light interceptor for moving the interceptor from the withdrawn position to the intercepting position.

The foregoing and/or other aspects of the present invention can be also achieved by providing a light scanning apparatus, comprising a light source; a frame supporting the light source and formed with a hole; a light interceptor that is disposed on a light traveling path of the light source and disposed in the hole so that it can be moved between an intercepting position in which light from the light source is intercepted and a withdrawn position in which the light interceptor is withdrawn from the intercepting position; and a sealing member that seals the hole while allowing the light interceptor to be moved in the hole.

The foregoing and/or other aspects of the present invention can be also achieved by providing a light scanning apparatus comprising a light source; a frame that supports and encloses the light source, wherein the frame defines an interior that contains the light source and a light traveling path of light from the light source, wherein the frame includes a stationary portion and a movable portion; a light interceptor that is disposed on the light traveling path, wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position; and a flexible sealing member that seals the gap or clearance.

The foregoing and/or other aspects of the present invention can be also achieved by providing an image forming apparatus comprising a photo sensitive body; a main body housing that receives the photo sensitive body; a cover that rotates for opening and closing the main body housing; a light source that scans light to the photosensitive body; a frame that supports and encloses the light source, wherein the frame defines an interior that contains the light source and a light traveling path of light from the light source, wherein the frame includes a stationary portion and a movable portion; a light interceptor that is disposed on the light traveling path and wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position; a flexible sealing member that seals the gap or clearance to prevent ambient particulates from entering the interior of the frame, and wherein the cover comprises an actuator that actuates the light interceptor to cause the light interceptor to be located at the intercepting position when the main body housing is opened by a rotation of the cover, and to cause the light interceptor to be located at the withdrawn position when the main body housing is closed by a rotation of the cover.

The foregoing and/or other aspects of the present invention can be also achieved by providing an image forming apparatus comprising a main body housing; a developer provided with a photo sensitive body and being attachable to and detachable from the main body housing; a light source that scans light to the photosensitive body; a frame that supports and encloses the light source, wherein the frame defines an interior that contains the light source and a light traveling path of light from the light source, and wherein the frame includes a stationary portion and a movable portion; a light interceptor that is disposed on the light traveling path, wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position; a flexible sealing member that seals the gap or clearance to prevent ambient particulates from entering the interior of the frame, and wherein the developer comprises an actuator that actuates the light interceptor and causes the light interceptor to be located at the withdrawn position when the developer is mounted to the main body housing, and that causes the light interceptor to be located at the intercepting position when the developer is detached from the main body housing.

### BRIEF DESCRIPTION OF THE DRAWINGS

These and/or other aspects and advantages of the invention will become apparent and more readily appreciated from the following description of the embodiments, taken in conjunction with the accompany drawings of which:

FIG. 1 is a schematic view showing a conventional image forming apparatus;

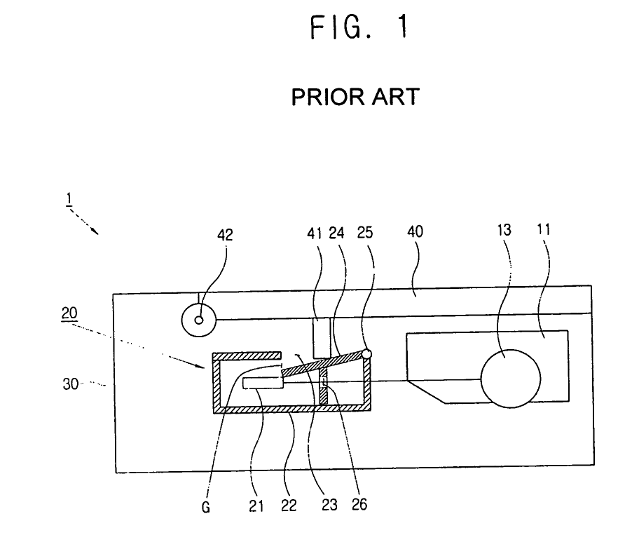

FIG. 2A is a schematic view showing an image forming apparatus according to a first embodiment of the present invention;

FIG. 2B is a schematic view showing the image forming apparatus of FIG. 2A;

FIG. 3 is a schematic view showing a light intercepting position of a light interceptor of FIG. 2;

FIG. 4A is a schematic view showing an image forming apparatus according to a second embodiment of the present invention;

FIG. 4B is a schematic view showing the image forming apparatus of FIG. 4A;

FIG. 5A is a schematic view showing an image forming apparatus according to a third embodiment of the present invention; and

FIG. 5B is a schematic view showing the image forming apparatus of FIG. 5A.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

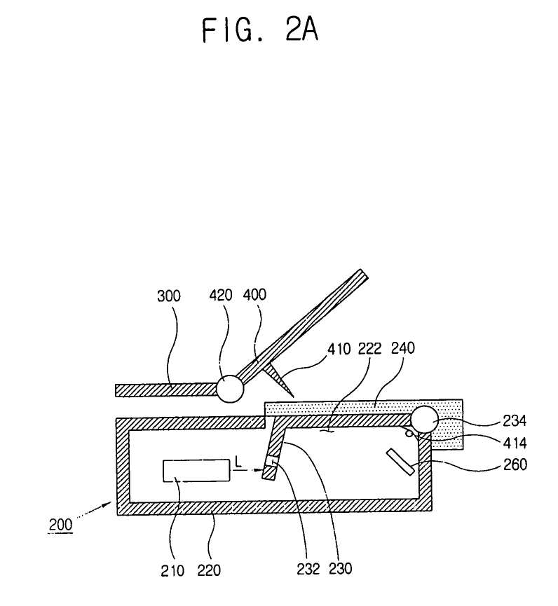

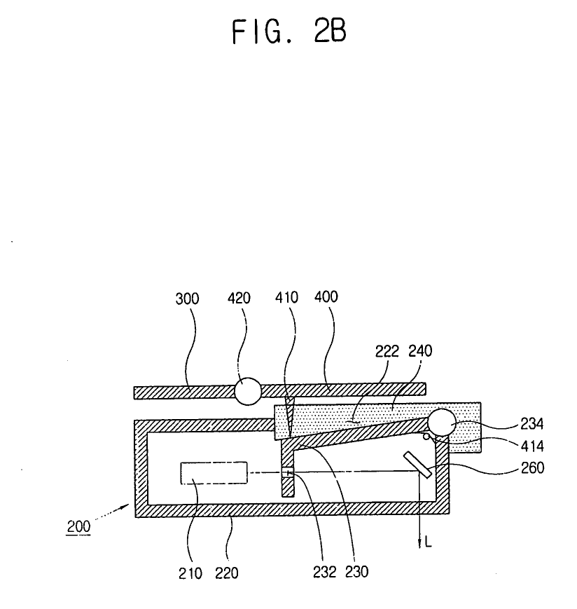

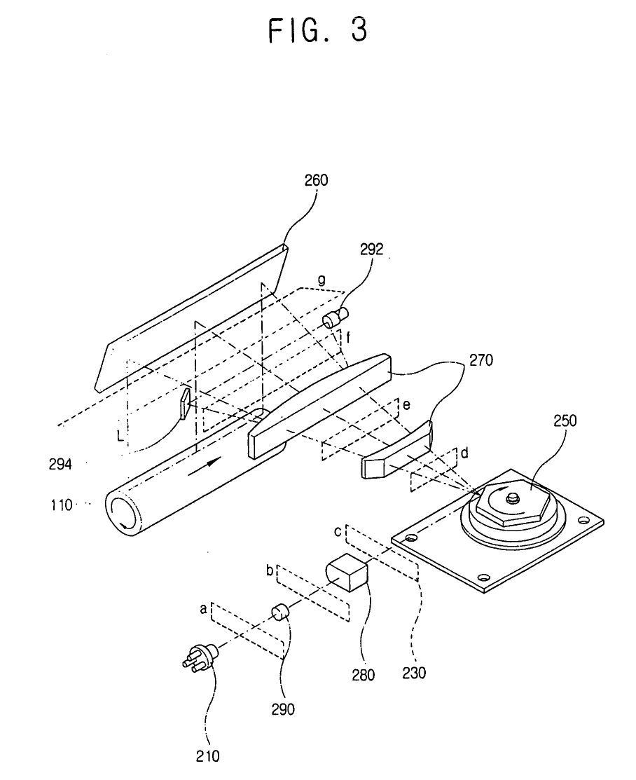

As shown in FIGS. 2 and 3, an image forming apparatus 10 comprises a photo sensitive body 110 and a light scanning unit 200. In the image forming apparatus 10, light is scanned to the photo sensitive body 110 to form an electrostatic latent image, a developing agent is applied to the electrostatic latent image to develop the electrostatic latent image and the developed electrostatic latent image is transferred to a printing paper to form an image on the printing paper. The image forming apparatus 10 may further comprise a feeding part (not shown) for feeding printing papers, a fuser (not shown) for fusing developing agent to the printing paper and a discharger (not shown) for discharging the printing paper to the outside. The image forming apparatus 10 may be a printer, a duplicator, a facsimile, a multi functional machine, or any other equipment similar to the above equipment.

The light scanning unit 200 comprises a light source 210, a frame 220, a light interceptor 230 and a sealing member 240. The light source 210 scans light to the photo sensitive body 110. The light source 210 is supported on the frame 220. A plurality of the light sources 210 may be provided. A laser diode, a light emitting diode (LED) device or other conventional light emitting devices may be used as the light source 210.

The frame 220 supports the light source 210 and is supported on a main body housing 300 so that the light source is able to direct light to the photo sensitive body 110. The frame 220 has a hole 222 for receiving the light interceptor 230. The light interceptor 230 may extend movably from the frame into the hole 222. It is desirable that the entire area of the frame 220 except the hole 222 for receiving the light interceptor 230 be sealed for preventing foreign substances from being introduced into the frame 220.

The light interceptor 230 is disposed on a traveling path of light from the light source 210 and extends movably into the hole 222, so that the light interceptor 230 is movable between an intercepting position in which the light L of the light source part 210 is intercepted and a withdrawn position in which the light interceptor is withdrawn from the intercepting position. As shown in FIG. 2A, when the light interceptor 230 is placed in the intercepting position, the light L from the light source 210 is intercepted by the light interceptor 230, and thus the light does not reach the photo sensitive body 110. Accordingly, the light L of the light source 210 is prevented from traveling outside the frame 220, thereby enhancing the security of users. As shown in FIG. 2B, when the light interceptor 230 is placed in the withdrawn position, the light L from the light source 210 reaches the photo sensitive body 110 without any interference from the light interceptor 230, so that the electrostatic latent image is formed on the photo sensitive body 110.

The light interceptor 230 may be rotatably combined with the frame 220 through a hinge part 234, and may be rotated in the hole 222. The light interceptor 230 may have a light slit 232 that is placed such that the light from the light source 210 can pass and travel through the light slit 232 when the light interceptor 230 is located at the withdrawn position. When the light interceptor 230 is rotated to the intercepting position, the light slit 232 is deviated from the light traveling path of the light source 210, so that the light interceptor intercepts the light L, whereas when the light interceptor 230 is rotated to the withdrawn position, the light slit 232 is arranged on the light traveling path of the light source 210 so that the light L travels through the light slit 232.

The light interceptor 230 is not limited to the embodiment in which the light interceptor has a light slit 232. The light interceptor 230 can include any configuration that can be moved between a position in which the light traveling path of the light source 210 is blocked and a position in which the light interceptor does not block the light traveling path. Also, the light interceptor 230 may be slidably attached to the frame 220 or can be movably combined with the frame 220 through other conventional structures that allow the light interceptor to move directly in the hole 222.

The sealing member 240 seals the hole 222 while allowing the light interceptor 230 to move in the hole 222. For intercepting the light L from the light source 210 with the light interceptor 230, the light interceptor 230 should movable in the hole 222. Accordingly, a clearance between the light interceptor 230 and the frame 220 may be generated, and thus, if the sealing member 240 were not present, developing agents, dust and other foreign substances could be introduced into the light scanning unit 200 through the clearance. The sealing member 240 seals the clearance, and thus prevents foreign substances from being introduced into the light scanning unit 200. Accordingly, it is possible to prevent the formation of a contaminated electrostatic latent image which can be caused by the foreign substances that interrupt, distort or intercept the travel of the light between the light source 210 and the photo sensitive body 10.

The sealing member 240 is provided so as to seal the hole 222 regardless of whether the light interceptor 230 is located at the position in which the light interceptor 230 intercepts the light or at the withdrawn position in which the light interceptor 230 is withdrawn from the intercepting position. The sealing member 240 seals the hole 222 so that the light interceptor 230 can be surrounded in the hole 222. When the cover 400 of the main body housing 300 is closed, which occurs by rotation of the cover 400, a first actuator 410 presses against the light interceptor 230. The sealing member 240 does not resist the pressing force of the first actuator 410 and is deformed. Accordingly, it is desirable that the sealing member 240 comprise a flexible material so as to enable the actuator 410 to press the light interceptor 230 without any disturbance. A sponge, tape or other conventional sealing material can be used as the sealing member 240.

The light scanning unit 200 is contained in the main body housing 300 of the image forming apparatus 10. The cover 400 is connected to the main body housing 300 by a hinge 420. The cover 400 is provided with the first actuator 410 that actuates or interacts with the light interceptor 230 for placing the light interceptor 230 at the intercepting position when the cover 400 is rotated to open the main body housing 300 and for placing the light interception part 230 at the withdrawn position when the cover part 400 is rotated to close the main body housing 300. The first actuator 410 may comprise a protrusion extending toward the light interceptor 230 so that when the cover 400 is rotated to close the main body housing 300, the first actuator 410 applies pressure to the light interceptor 230 to enable the light interceptor to move from the intercepting position to the withdrawn position. The first actuator 410 may press the light interceptor 230 together with the sealing member 240.

When the cover 400 is rotated to open the main body housing 300, the pressure on the light interceptor 230 applied by the first actuator 410 is released so that the light interceptor 230 can move from the withdrawn position to the intercepting position to intercept the light L. Since the first actuator 410 enables the light interceptor 230 to move between the withdrawn position and the intercepting position in response to the rotation of the cover 400 for opening/closing the main body housing 300, various conventional shapes may be used for the first actuator 410 instead of a protrusion shape. Also, the first actuator 410 may comprise a switching device comprising a solenoid valve.

In order to move the light interceptor 230 from the withdrawn position to the intercepting position, an elastic member 414 may press against the light interceptor 230 so that when the cover 400 is rotated and opened and the pressure applied by the first actuator 410 is released, the elastic member 414 allows the light interceptor 230 to move smoothly from the withdrawn position to the intercepting position. The elastic member 414 can be disposed between the frame 220 and the light interceptor 230 or can be disposed at another position. The elastic member 414 may comprise a coil spring, a plate spring or other conventional members having an elastic restoration force. Also, the light interceptor 230 may move from the withdrawing position to the intercepting position by an elastic restoration force of material itself, the force of gravity or other configuration.

Hereinafter, an operation of the image forming apparatus according to the first embodiment of the present invention will be described, taken in conjunction with FIGS. 2A and 2B and FIG. 3. In a normal state in which the image forming apparatus 10 performs an image forming function and the like, the light interceptor 230 is pressed by the first actuator 410 of the cover 400, and thus the light interceptor 230 is placed in the withdrawn position. The light L of the light source 210 passes through the light slit 232 to form an image on the photo sensitive body 110. In this position, the sealing member 240 seals the hole 222 and prevents foreign substances such as developing agents dispersed in the main body housing 300 from being introduced into the frame 220 through the hole 222.

When the user rotates and opens the cover 400, for example, to eliminate trouble caused by jamming or other various causes, the light interceptor 230 is released from the pressure exerted by first actuator 410 and is moved from the withdrawn position to the intercepting position by an elastic restoration force of the elastic member 414. Accordingly, the light slit 232 is moved away from the light traveling path, and thus, the light interceptor 230 intercepts the light L from the light source 210 to prevent the user from being exposed to the light. In this position, the sealing member 240 continues to seal the hole 222 to prevent foreign substances from being introduced into the frame 220 through the hole 222. In particular, foreign substances accumulated in the main body housing 300 may be dispersed by a shock generated when the cover 400 is opened, or foreign substances existing outside of the main body housing 300 may be introduced into the main body housing 300. However, the sealing member 240 effectively seals the hole 222 even when the amount of foreign substances increases.

As described above, in the image forming apparatus 10, the light interceptor 230 is operated in a simple manner in response to an opening or closing of the cover 400 to allow normal operations of the image forming apparatus 10 when the cover 400 is closed and to prevent the user from being exposed to light L from the light source 210 when the cover is opened. The sealing member 240 seals the clearance formed by movement of the light interceptor 230 to prevent foreign substances from being introduced into the frame 220.

Hereinafter, the light intercepting position of the light interceptor 230 will be described taken in conjunction with FIG. 3. As shown in the drawing, the light scanning unit 200 is provided with a polygon mirror 250 for diffusing and reflecting the light L from the light source part 210 in a specific direction. The polygon mirror 250 is rotated at a high speed and diffuses and reflects the light L from the light source part 210 in a main scanning direction to make the light travel to the photo sensitive body 110. In addition to the polygon mirror 250, the light scanning unit 200 may be provided with a plurality of lenses and mirrors disposed on the light traveling path between the light source part 210 and the photo sensitive body 110 to modify optical characteristics of the light L.

A collimator lens 290 adjusts the light L scanned from the light source 210 so as to make the light travel in parallel with an optical axis. A cylindrical lens 280 is disposed between the light source 210 and the polygon mirror 250 to converge the light L scanned from the light source 210 in a sub scanning direction. A scanning lens 270 converges the light L reflected from the polygon mirror 250 in the main scanning direction. A reflecting mirror 260 reflects the light L passed through the scanning lens 270 in a specific direction to form the image on the photo sensitive body 110. A synchronizing sensor 292 adjusts a light scanning synchronization of the light source 210 together with a synchronizing mirror 294.

The light interceptor 230 can disposed in at least one of the positions a through g between the light source 210 and the photo sensitive body 110, to intercept the light L from the light source 210. The light interceptor 230 can intercept the light L from the light source 210 on the path traveling path (at least one of the positions a through c) between the light source 210 and the polygon mirror 250. Since the light L is diffused as it travels in the main scanning direction at a downstream side of the polygon mirror 250 (the positions d through g), the width of the light interceptor 230 should be relatively large if it is placed in one of these positions. However, since the light L travels linearly at an upstream side of the polygon mirror 250 (the positions a through c), the width of the light interceptor 230 may be relatively narrow if it is placed in one of these positions. In particular, it is desirable to place the light interceptor 230 between the cylindrical lens 280 and the polygonal mirror 250 (position c). The light interceptor 230 may also be disposed between the polygonal mirror 250 and the scanning lens 270 or between the scanning lens 270 and the reflecting mirror 260. Since there is a large space between the polygonal mirror 250 and the scanning lens 270 and between the scanning lens 270 and the reflecting mirror 260, the light interceptor 230 can be placed conveniently in these positions.

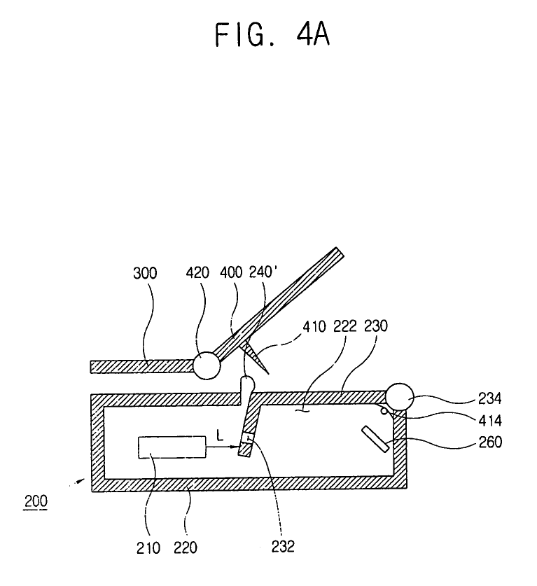

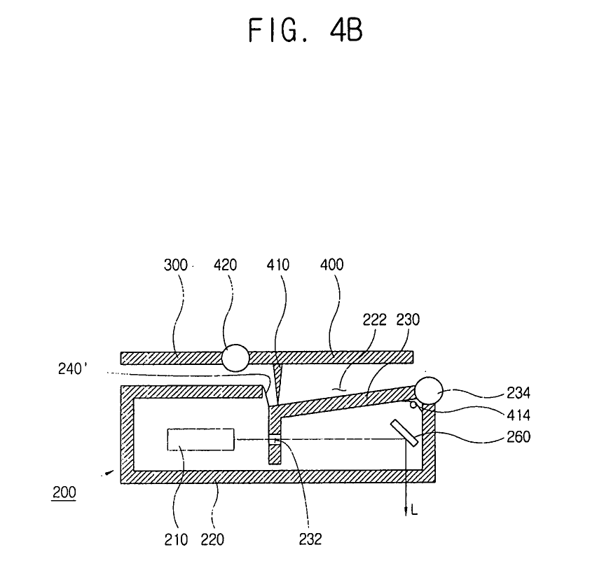

Hereinafter, an image forming apparatus according to a second embodiment of the present invention will be described, taken in conjunction with FIG. 4A and FIG. 4B.

FIG. 4A shows a state in which the cover part is opened, and FIG. 4B shows a state in which the cover part is closed. As shown in the above drawings, a sealing member 240′ is disposed between the light interceptor 230 and the frame 220 so as to seal a clearance between the light interceptor 230 and an inner circumference of the hole 222 used for receiving the light interceptor. It is desirable that the sealing member 240′ be made from a flexible material.

One side of the sealing member 240′ is supported on the frame 220 and the other side is supported on the light interceptor 230 so that the sealing member 240′ allows the light interceptor 230 to move smoothly between the withdrawn position and the intercepting position and seals the hole 222 for receiving the light interceptor. It is desirable that the sealing member 240′ be positioned so that the sealing member does not contact the first actuator 410 when the first actuator 410 presses the light interceptor 230 or when the first actuator 410 is released from pressing the light interceptor 230. The sealing member 240′ may be made from a material having an excellent elasticity and durability.

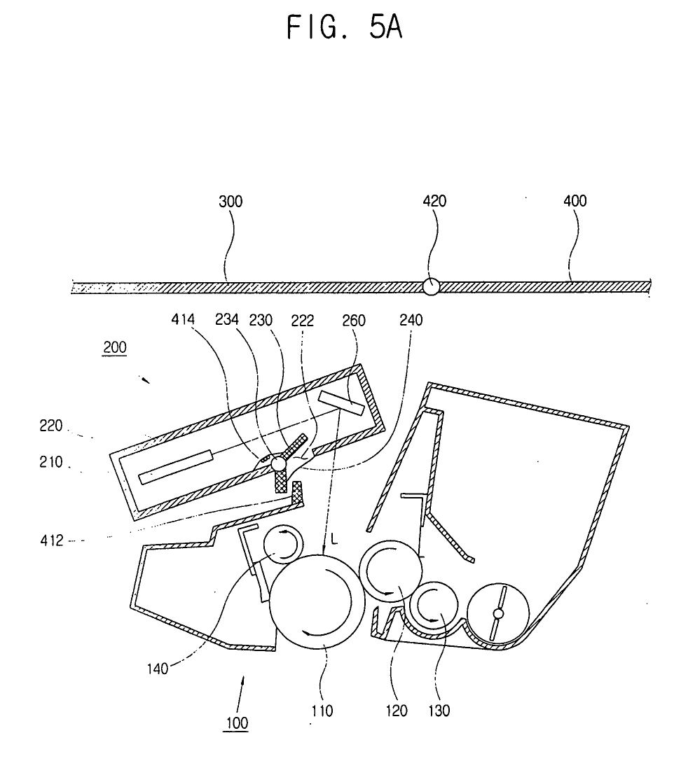

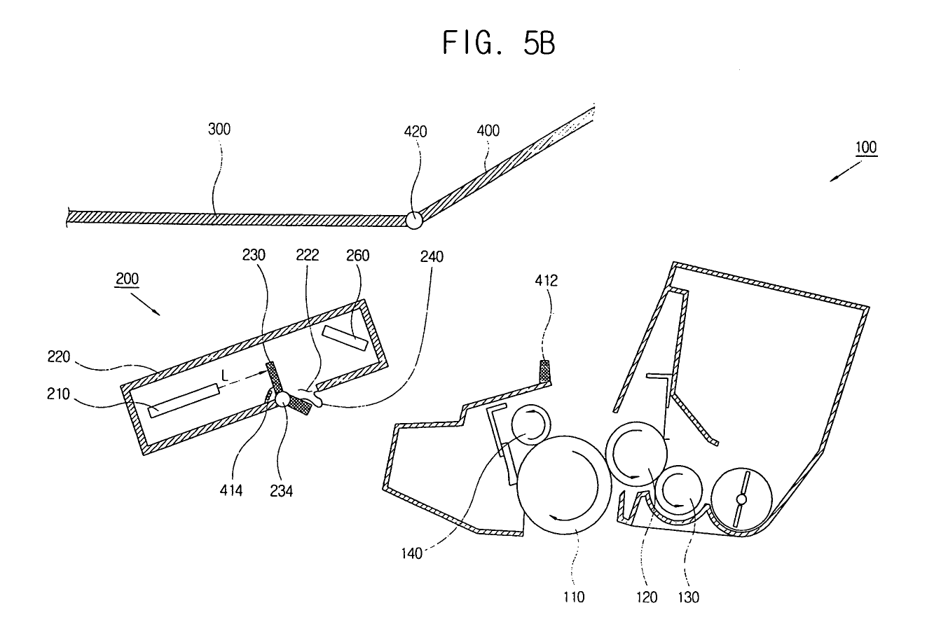

Hereinafter, an image forming apparatus according to a third embodiment of the present invention will be described, taken in conjunction with FIGS. 5A and 5B.

FIG. 5A shows an image forming apparatus in which a developing unit 100 is mounted to the main body housing 300 and FIG. 5B shows the image forming apparatus in which the developing unit 100 has been detached from the main body housing 300. As shown in the drawings, the developing unit 100 is provided with a photo sensitive body 110, an electrifying roller 140, a developing roller 120 and a feeding roller 130. The photo sensitive material on the photo sensitive body 110 interacts with the electrifying roller 140, the developing roller 120 and a transfer charge roller (not shown) in order, and thus an image forming process is performed. After the electrifying roller 140 electrifies the photo sensitive body 110 to eliminate a potential difference, the light scanning unit 200 scans light to form an electrostatic latent image. The developing roller 120 supplies developing agent onto the electrostatic latent image to develop the latent image. The transfer charge roller (not shown) is disposed in the main body housing 300, and transfers the developing agent applied on the photo sensitive body 110 to printing paper that is passed between the transfer charge roller and the photo sensitive body.

The developing unit 100 may be detached from the main body housing 300 when the developing agent is exhausted or for other reasons. In the process of detaching the developing unit 100, there is a danger that the user could be exposed to the light L from the light source part 210. To prevent this problem, the light interceptor 230 is positioned at the intercepting position when the developing unit 100 is detached from the main housing body 300 so that it intercepts the light L from the light source part 210. When the developing unit 100 is put back in place in the main body housing 300, the light interceptor 230 is positioned in the withdrawn position so that the light L from the light source 210 is able to travel to the photo sensitive body.

The developing unit 100 is provided with a second actuator 412 for placing the light interceptor 230 in the withdrawn position when the developing unit is mounted in the main body housing 300 and for placing the light interceptor 230 in the intercepting position when the developing unit 100 is detached from the main body housing 300. The light interceptor 230 is rotatably combined with the frame 220 through the hinge 234. When the developing unit 100 is in place in the main body housing 300, the second actuator 412 presses on the light interceptor 230 so that the light interceptor 230 is located in the withdrawn position and does not intercept the light L of the light source part 210 (FIG. 5A). A sealing member 240 seals the hole 222 for receiving the light interceptor 230 so that the light interceptor 230 can be rotated without foreign substances being introduced. When the developing unit 100 is detached from the main body housing 300, the second actuator 412 no longer presses on the light interceptor 230, and the light interceptor 230 is moved to the intercepting position in which the light interceptor 230 intercepts the light L of the light source part 210 (FIG. 5B). In the same manner, the sealing member 240 seals the hole 222 for receiving the light interceptor 230 to prevent foreign substance from being introduced. The sealing member 240 surrounds and seals the hole 222 such that the light interceptor 230 is received in the hole, or the sealing member 240 is disposed between the light interceptor 230 and the frame 220 to enable the sealing member 240 to seal the hole 222.

Hereinafter, the light scanning apparatus according to the embodiment of the present invention will be described taken in conjunction with FIGS. 2A and 2B. As shown in the drawings, the light scanning apparatus according to the embodiment of the present invention is provided with a light source 210, a frame 220, a light interceptor 230 and a sealing member 240.

The light source 210 emits light, the frame 220 supports the light source part 210 and has a hole 222 through which the light interceptor 230 moves. The light interceptor 230 is disposed on a light traveling path of the light source 210 and received movably in the hole 222, so that the light interceptor 230 can be moved between the intercepting position at which the light L from the light source 210 is intercepted and the withdrawn position in which the light interceptor 230 is withdrawn from the intercepting position. The sealing member 240 seals the hole 222, and seals any clearance space between the light interceptor 230 and the frame 220 while allowing the light interceptor 230 to be moved in the hole 222.

In the image forming apparatus and the light scanning apparatus according to aspects of the present invention, the light interceptor controls the passage or interception of the light from the light source in response to at least one of the opening/closing of the cover part or the attachment/detachment of the developing unit. In addition, the image forming apparatus and the light scanning apparatus according to aspects of the present invention can be configured so that light interceptor controls the passage or interception of light from the light source part in response to any other condition in which the user may be exposed to light from the light source.

As described above, in the image forming apparatus and the light scanning apparatus, it is possible to prevent ambient particulates, such as dust, developing agents and other foreign substances from being introduced into the light scanning unit through a gap which is formed due to movement of the light interceptor in response to opening/closing of the cover part or attachment/detachment of the developing unit.

Accordingly, it is possible to prevent the formation of contaminated electrostatic latent images that may be caused by the interception of light from the light source by foreign substances introduced into the light scanning unit. It is thereby possible to prevent the contaminated images from forming on the photo sensitive body and from being printed on the printing paper.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus having a photosensitive body, comprising:
a light source that scans light to the photosensitive body;
a frame supporting the light source and formed with a hole;
a light interceptor that is disposed on a light traveling path of light from the light source and that is disposed in the hole so as to be movable between an intercepting position in which the light from the light source is intercepted and a withdrawn position in which the light interceptor is withdrawn from the intercepting position; and
a sealing member that seals the hole while allowing the light interceptor to be moved in the hole.

2. The image forming apparatus according to claim 1, further comprising a polygon mirror that diffuses and reflects light from the light source in a specific direction, and wherein the light interceptor intercepts the light from the light source on the light traveling path between the light source and the polygon mirror.

3. The image forming apparatus according to claim 2, further comprising a cylindrical lens between light source and the polygon mirror and wherein the light interceptor intercepts light between the cylindrical lens and the polygon mirror.

4. The image forming apparatus according to claim 1, further comprising a polygon mirror that diffuses and reflects light from the light source in a specific direction and a scanning lens disposed between the polygon mirror and the photo sensitive body to converge the light reflected from the polygon mirror in a specific direction, and wherein the light interceptor intercepts light from the light source on the light traveling path between the polygon mirror and the scanning lens.

5. The image forming apparatus according to claim 1, further comprising a scanning lens that converges light from the light source in a specific direction and a reflecting mirror disposed between the scanning lens and the photo sensitive body to reflect the light from the light source part in a specific direction, and wherein the light interceptor intercepts light from the light source on the light traveling path between the scanning lens and the reflecting mirror.

6. The image forming apparatus according to claim 1, wherein the sealing member seals the hole so that the light interceptor can be surrounded by the sealing member, and wherein the sealing member is made from a flexible material.

7. The image forming apparatus according to claim 6, wherein the sealing material is made from sponge or tape.

8. The image forming apparatus according to claim 1, wherein the sealing member is disposed between the light interceptor and the frame to seal a clearance formed around the light interceptor received in the hole, and wherein the sealing member is made from a flexible material.

9. The image forming apparatus according to claim 1, wherein the light interceptor is rotatably combined with the frame for rotating between the intercepting position and the withdrawn position.

10. The image forming apparatus according to claim 9, wherein the light interceptor has a light slit through which light from the light source passes when the light interceptor is located at the withdrawn position.

11. An image forming apparatus including a photo sensitive body, a main body housing that receives the photo sensitive body and a cover that rotates for opening and/or closing the main body housing, comprising:
a light source that scans light to the photo sensitive body;
a frame supporting the light source and formed with a hole;
a light interceptor that is disposed on a light traveling path of the light source part and that is disposed in the hole so as to be movable between an intercepting position in which light from the light source is intercepted and a withdrawn position in which the light interceptor is withdrawn from the intercepting position; and
a sealing member that seals the hole while allowing the light interceptor to be moved in the hole,
wherein the cover comprises a first actuator that actuates the light interceptor to cause the light interceptor to be located at the intercepting position when the main body housing is opened by a rotation of the cover, and to cause the light interceptor to be located at the withdrawn position when the main body housing is closed by a rotation of the cover.

12. The image forming apparatus of claim 11 wherein the actuator comprises a switching device comprising a solenoid valve.

13. The image forming apparatus according to claim 11, further comprising an elastic member that presses the light interceptor to move the light interceptor from the withdrawn position to the intercepting position.

14. An image forming apparatus having a main body housing and a developer provided with a photo sensitive body and being attachable to and detachable from the main body housing, comprising:
a light source that scans light to the photo sensitive body;
a frame that supports the light source and that is formed with a hole;
a light interceptor that is disposed on a light traveling path of the light source and that is disposed in the hole so as to be movable between an intercepting position in which light from the light source is intercepted and a withdrawn position in which light intercepting part is withdrawn from the intercepting position; and
a sealing member that seals the hole while allowing the light interceptor to be moved in the hole,
wherein the developer comprises a second actuator that actuates the light interceptor and causes the light interceptor to be located at the withdrawn position when the developer is mounted to the main body housing, and that causes the light interceptor to be located at the intercepting position when the developer is detached from the main body housing.

15. The image forming apparatus according to claim 14, further comprising an elastic member that applies pressure to the light interceptor to move the interceptor from the withdrawn position to the intercepting position.

16. A light scanning apparatus, comprising:
a light source;
a frame supporting the light source and formed with a hole;
a light interceptor that is disposed on a light traveling path of the light source and that is disposed in the hole so that it can be moved between an intercepting position in which the light from the light source is intercepted and a withdrawn position in which the light interceptor is withdrawn from the intercepting position; and
a sealing member sealing the hole while allowing the light interceptor to be moved in the hole.

17. An image forming apparatus comprising:
a photo sensitive body;
a main body housing that receives the photo sensitive body;
a cover that rotates for opening and closing the main body housing;
a light source that scans light to the photosensitive body;
a frame that supports and encloses the light source, wherein the frame defines an interior that contains the light source and a light traveling path of light from the light source, and wherein the frame includes a stationary portion and a movable portion;
a light interceptor that is disposed on the light traveling path, wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position;
a flexible sealing member that seals the gap or clearance to prevent ambient particulates from entering the interior of the frame, and
wherein the cover comprises an actuator that actuates the light interceptor to cause the light interceptor to be located at the intercepting position when the main body housing is opened by a rotation of the cover, and to cause the light interceptor to be located at the withdrawn position when the main body housing is closed by a rotation of the cover.

18. An image forming apparatus comprising:
a main body housing;
a developer provided with a photo sensitive body and being attachable to and detachable from the main body housing;
a light source that scans light to the photosensitive body;
a frame that supports and encloses the light source, wherein the frame defines an interior that contains the light source and a light traveling path of light from the light source, and wherein the frame includes a stationary portion and a movable portion;
a light interceptor that is disposed on the light traveling path, wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position;
a flexible sealing member that seals the gap or clearance to prevent ambient particulates from entering the interior of the frame, and
wherein the developer comprises an actuator that actuates the light interceptor and causes the light interceptor to be located at the withdrawn position when the developer is mounted to the main body housing, and that causes the light interceptor to be located at the intercepting position when the developer is detached from the main body housing.

19. A light scanning apparatus, comprising:
a light source;
a frame that supports and encloses the light source, wherein the frame defines an interior that contains the light source and a light traveling path of light from the light source, and wherein the frame includes a stationary portion and a movable portion;
a light interceptor that is disposed on the light traveling path, wherein the light interceptor is coupled with or integrally formed with the movable portion of the frame so that the light interceptor is movable between an intercepting position in which the light from the light source is intercepted and a withdrawn position in which the light interceptor does not intercept light from the light source and wherein a gap or clearance is defined between the stationary portion and the movable portion of the frame when the light interceptor is in the intercepting position and/or when the light interceptor is in the withdrawn position; and
a flexible sealing member that seals the gap or clearance.
